(19) United States
(12) Patent Application Publication
(10) Pub. No.: US 2026/0089055 A1
(43) Pub. Date: Mar. 26, 2026

(54) AGGREGATING SERVICE AND DEPLOYMENT CONFIGURATION

(71) Applicant: MICROSOFT TECHNOLOGY LICENSING, LLC, Redmond, WA (US)

(72) Inventors: James Duncan PARSONS, Hatfield (GB); George Arthur BLACKBURN, London (GB); Dhaval Kiran SONEJI, London (GB)

(21) Appl. No.: 18/916,628

(22) Filed: Oct. 15, 2024

Related U.S. Application Data
(60) Provisional application No. 63/697,420, filed on Sep. 20, 2024.

(51) Int. Cl. H04L 41/0806

(52) U.S. Cl. CPC H04L 41/0806

(57) ABSTRACT

A desired configuration is generated for injection into a first network element of a deployment comprising a plurality of network elements including the first network element, each network element comprised in a communications network. A service configuration is received, the service configuration being configuration independent of information about specific network elements, the service configuration defining functionality to be applied to the deployment. A deployment configuration is received defining information about deployment of the first network element. The service configuration and the deployment configuration are aggregated to generate a desired configuration for injection into the first network element.

### CROSS-REFERENCE TO RELATED APPLICATION

This application claims the benefit of U.S. provisional application No. 63/697,420 filed on Sep. 20, 2024, entitled “Aggregating service and deployment configuration” the entirety of which is hereby incorporated by reference herein.

### BACKGROUND

Network elements, especially in communications networks, often need to be controlled by a network infrastructure provider or operator. Examples of such network elements include session border controllers, firewalls, routers, and switches. Changes to network element configuration are made for many different reasons, such as maintenance, upgrade, configuration of services, troubleshooting and other reasons.

In some cases, network elements are configured by a manual login to an individual network element using a command line interface (CLI), which is time consuming and complex. Additionally, when applying changes manually over a plurality of network elements, configuration via a CLI is difficult to scale. Moreover, configuration of a network element is in some cases in the form of non-human friendly information such as a Management Information Base (MIB), therefore determining what configuration changes to make can be difficult.

The embodiments described below are not limited to implementations which solve any or all of the disadvantages of known ways of configuring network elements.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

In various examples, a human telco operator or other engineer is able to use two types of configuration: service configuration and deployment configuration, in order to facilitate scalable, efficient, human-friendly configuration of complex communications networks. Aggregation of service configuration and deployment configuration may be computed to produce a desired configuration for injection into a network element of a deployment, in some cases each network element in a deployment.

In various examples, a computer-implemented method for generating a desired configuration for injection into a first network element of a deployment comprising a plurality of network elements including the first network element, each network element comprised in a communications network, is disclosed. The method comprises receiving a service configuration, the service configuration being configuration independent of information about specific network elements, the service configuration defining functionality to be applied to the deployment, and receiving a deployment configuration defining information about deployment of the first network element. The method further comprises aggregating the service configuration and the deployment configuration to generate a desired configuration for injection into the first network element.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a plurality of network elements in a communications network;

FIG. 2 is a schematic diagram of two network elements with adjustable configuration;

FIG. 3 is a schematic diagram of two network elements each of which have desired configuration for injection generated by a configuration translator;

FIGS. 4A and 4B are flow diagrams of a method performed to generate a desired configuration using deployment and service configuration, for injection into a network element;

FIG. 5 illustrates an exemplary computing-based device in which embodiments of the disclosed technology for generating a desired configuration for injection into a network element are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples. However, the same or equivalent functions and sequences may be accomplished by different examples.

As mentioned above, network elements such as telecoms network elements, session border controllers, firewalls, routers and/or switches often need to be controlled by a communications network infrastructure provider or operator. A service may be provided over the communications network such as a voice over internet protocol service or other service. Often the service may need to be re-configured such as to change routes of traffic flows or to change how traffic is treated by particular network elements. This type of re-configuration of a service to adjust routes of traffic flows or change how traffic is treated by particular network elements may be done frequently such as several times a day. The changes and adjustments enable coping with traffic volume fluctuations due to factors such as time of day, failure of network elements, maintenance of network elements, and other factors. However, implementation of the re-configuration is not straightforward since configuration, such as declarative configuration, has to be written by an engineer with expert knowledge of the network architecture and knowledge of the service. Additionally, configuration is in some cases provided independently to different network elements of a deployment, and in further cases adjustments, such as same adjustments made to network element configuration, may also be made to deployment configuration of a deployment associated with the network elements. An engineer must therefore ensure that no discrepancies are introduced and take the time to duplicate their adjustments to configuration across deployment configuration and network element configuration.

When a network element is configured, the configuration is typically sent to two places:
a virtualization layer (such as Kubernetes (trade mark), vSphere (trade mark), OpenStack (trade mark) etc.). This is the information required to deploy the network element containers/virtual machines (VMs). It includes information like the number of network elements in a deployment of the network element, their hardware requirements (central processing unit CPU, disk, memory etc.) and how they should be attached to the network, internet protocol IP addresses, subnets, network interface cards NICs etc.
The Network Element itself. This is the configuration for the network element.

There may be some overlap between the information that the network element needs to know and the information the virtualization layer is to know. For example:
The network element's own IP address.
The network element's hardware (CPU etc.) might be used to determine how much traffic the network element can handle.
The IP addresses of various of the network element's peer network elements that the network element is to route traffic to

There are a few difficulties with this arrangement. The user having to enter the same information in two places is inefficient. It leaves the possibility of user error with the user entering different values in the two sets of configuration by mistake. That can cause harmful issues that are complex to debug. The configuration on each of the network elements is subtly different because of the different IP addresses. This leads to separate configuration files and more places where things can malfunction.

The present technology ameliorates one of more of the above issues by having a configuration translator node query the virtualization layer for any deployment configuration and receive the rest of the service configuration from an operator. The two types of configuration are then combined together (referred to as aggregation) and converted to the correct format (i.e. MIBs) to supply to each of the network elements (each network element may have a slightly different configuration file because of the IP addresses as is mentioned above). There is then no duplication of configuration. Each piece of configuration either goes in the deployment configuration and is supplied to the virtualization layer, or it goes in the service configuration. Instead of having to supply subtly different configuration to each of the network elements an operator is able to supply a single service configuration file for a whole deployment of potentially many network elements.

In some examples, the present technology enables the service configuration to be agnostic to the number of network elements in a deployment. Therefore, to scale the deployment up or down only the deployment configuration is to be changed, meaning that an operator can be confident the service provided by the deployment will stay the same, only it's capacity will change as network elements are added or taken away.

In various examples, the present technology enables use of two different types of configuration to control one or more network elements in a communications network that are used to provide a service, such as a voice over internet protocol service. A first type of configuration is referred to herein as deployment configuration and is suitable for configuring a deployment of individual network elements, the deployment configuration defining deployment-specific information that is further specific to network elements of the deployment. A second type of configuration is referred to herein as service configuration and is usable such as by an engineer to configure one or more network elements implementing a service, such as a voice over internet protocol service, in the communications network. Service configuration is deployment-agnostic i.e. is independent of deployment-specific information, and only a single service configuration (rather than multiple service configurations) is enabled to be provided to configure network elements of a deployment. In some examples, the deployment configuration is independent of the service configuration; that is, the service configuration may be changed without affecting the deployment configuration. By having two different types of configuration (the service configuration and the deployment configuration) engineers are able to more efficiently manage network elements that are providing a communications network service, and configure network elements in a scalable way. Using the service configuration an engineer or other entity is able to configure a plurality of network elements without needing to know details about how to configure the individual network elements. Additionally, aggregating service and deployment configuration means that an engineer does not need to duplicate configuration adjustments where the configuration that is adjusted would otherwise be duplicated across configuration of a deployment and configuration for a specific network element.

Configuration provided to each network element of a deployment is at least different because of different IP addresses, which means that network elements are configured independently of each other, which increases a chance of introducing an error especially when configuration is applied to many network elements of a deployment.

A network element typically is configured to receive only one type of configuration and if it receives configuration that it does not recognize or understand that configuration is ignored. Therefore in order to enable network elements to be configured using aspects of a deployment configuration and a service configuration, the present technology uses an aggregation process as described in more detail below.

Increasingly, network element functionality is deployed using containers, where a container is software together with any libraries, dependencies and configuration files needed to execute the software. A container is portable between computing environments in that it is able to execute on different computing environments that it is ported between. A software container is independent of its computing environment. In cases where a network element comprises a container, the container often needs to be controlled.

In an approach, a declarative configuration is provided to a network element, in some cases being provided to a container of the network element, or a virtual machine deploying the network element, or another computing entity deploying the network element. A declarative configuration defines a high-level desired state to be reached, where a receiving computing entity determines, in some approaches, how to achieve the state of the declarative configuration.

In contrast, in other approaches, an imperative configuration is provided to a network element, in some cases being provided to a container of the network element. An imperative configuration defines specific, lower-level configuration than a higher-level declarative configuration, comprising instructions for example to update a field in a specified way or to set a value of a parameter. An imperative configuration may comprise a list of instructions to be executed in order arrange a network element according to the configuration.

Using declarative configuration is more scalable than in approaches where a manual login to a CLI is required to adjust configuration of, or where imperative configuration is provided to, a network element. This is because a declarative configuration can be applied to a plurality of network elements without specifically tailoring instructions to each individual network element, and/or without risking introducing errors and inconsistencies especially between network elements that have had their configurations adjusted and those that have not.

A network element in various approaches comprises a current configuration. In some cases the current configuration is a MIB and in some cases the current configuration is a low-level configuration, referring to the configuration being directly interpretable by computer hardware rather than being interpretable easily by humans. The current configuration defines values of variables and parameters, and enables functionality of the network element. In some cases, a network element comprises a plurality of current configurations, such as modules of current configuration, for example that enable different functionalities of the network element, in some examples each current configuration being a low-level configuration. Low-level configuration in this context refers to configuration interpretable by computer hardware, defining specific variables and parameters used by the network element and/or by traffic routed via (including being destined for) the network element.

Though such a current configuration in various examples is adjusted using an imperative configuration, in an approach, a declarative configuration is provided to a network element, and the declarative configuration is mapped to an imperative configuration suitable for adjusting the current configuration of the network element to the state defined by the provided declarative configuration.

Configuration is injected into a network element, in some cases into a container of the network element or a virtual machine of the network element, where injection refers to providing and applying the configuration. For example, a declarative configuration being injected into a network element refers to the declarative configuration being provided to the network element, mapped to an imperative configuration, and the imperative configuration being applied to the network element such that the network element is configured as defined by the imperative configuration.

In an approach, making configuration changes is performed by injecting desired configuration into each of a plurality of network elements, in various examples being a plurality of containers. In the event that a deployment of the plurality of network elements is adjusted, for example in the event that an additional network element, for example a container, is added to the plurality of elements to be configured, a desired configuration may be tailored to the additional element. In other examples, a configuration for the other elements of the plurality of network elements may be adjusted by injecting a new desired configuration. Performing such adjustments manually via a CLI, determining what adjustments to make across network element configuration and configuration of a deployment in the event of a change in desired configuration of the plurality of network elements, and making changes to respective network element and deployment configuration, can be challenging and time consuming.

In various examples there is a computer-implemented method for generating a desired configuration for injection into a first network element of a deployment comprising a plurality of network elements including the first network element, each network element comprised in a communications network, which may be where a service, such as a voice over internet protocol service, is deployed. The method comprises receiving a service configuration, the service configuration being configuration independent of deployment-specific information, and the service configuration defining functionality to be applied to the deployment. The service configuration may be specified by an engineer or other entity managing the voice over internet protocol service and in some cases the service configuration may change relatively frequently according to changes in the functionality of the communications network.

The network element also receives a deployment configuration defining deployment-specific information associated with the first network element. The deployment configuration may be values passed to a Helm chart, or may be other configuration for deploying individual network elements of the communications network. Typically the deployment configuration is changed significantly less frequently than the service configuration.

An entity such as the network element itself, or another entity in the communications network, aggregates the service configuration and the deployment configuration to generate a desired configuration. The desired configuration may be injected into the first network element such as by sending instructions into the network element. As a result of sending the instructions into the network element the configuration of the network element is updated according to the aggregated service and deployment configuration. This reduces a need for an engineer to tailor desired configuration to each network element of a deployment, as a service configuration is enabled to be provided which is then aggregated to generate desired configuration. Additionally, adjustments to configuration do not need to be duplicated across both service and deployment configuration, due to the aggregation process, which reduces a chance of errors that are difficult to debug being introduced.

The network element of the disclosure operates in an unconventional manner to aggregate two different types of configuration so as to facilitate management of the network element as part of a service being provided using a communications network of which the network element is part.

The aggregation of two different types of configuration improve the functioning of the underlying network element by enabling changes desired for a service deployed in the communications network to be made efficiently and in a scalable way.

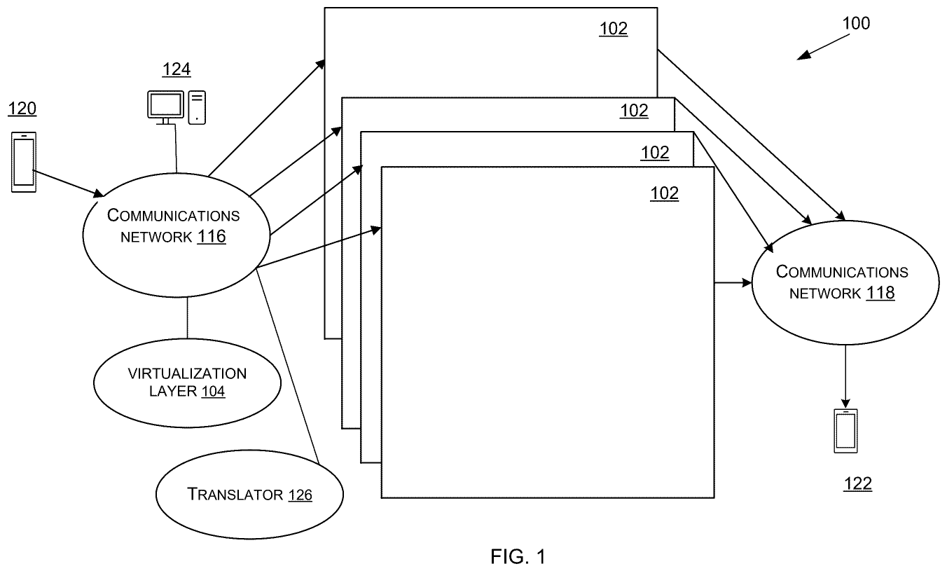

FIG. 1 is a schematic diagram of a plurality of network elements 102 in a communications network 100 such as a wired or wireless communications network for transmitting packet-based communications such as voice over internet protocol calls. The communications network is a 5G communications network in some cases, and for example the network elements 102 are telephony network elements or other network elements of a complex communications network. In some cases the telephony network elements are 5G communications network elements. The communications network 100 comprises a first communications network 116 and a second communications network 118 and in this example the network elements link the first communications network 116 to the second communications network 118 such as where the network elements are session border controllers (SBCs). However, the network elements may be of other types, such as but not limited to, firewalls, routers, switches. The network elements may be located anywhere in the communications network 100 according to a particular function or use case of the network elements. Each network element is computer hardware, in some cases executing a container implementing functionality of the network element.

One or more end user communication devices are shown including smart phones 120, 122 and desktop computer 124 to illustrate that calls may be established over the communications network 100 between end user communication devices. Other types of end user communication device may be used.

A virtualization layer 104 is in various examples connected to the communications network 100. The virtualization layer is computer implemented functionality for controlling instantiation of containers/VMs, deleting containers/VMs, and configuring containers/VMs. The virtualization layer in various examples receives input from a network operator or infrastructure provider via one of the end user devices such as desktop computer 124 in order to specify how network services are to be orchestrated. By using the virtualization layer 104 it is possible to have the virtualization layer send configuration files i.e. a configuration, to the network elements 102. In cases where a network element 102 comprises a container or VM, the virtualization layer 104 is used to send a configuration to the container or VM of the network element 102.

As defined herein, a deployment comprises at least one network element 102, and refers to an implementation of the at least one network element 102 within a communications network. In some cases, a deployment is configured by a deployment, where configuration of a deployment comprises parameters, values and variables associated with the deployment and which are in some cases used to set up the deployment, including connections, topology, addresses of elements of the deployment and/or scale of the deployment. In some cases, a deployment is managed by an virtualization layer 104, or other entity associated with the deployment. In various examples, deployment configuration refers to configuration of the deployment, and is used by the virtualization layer 104 or other entity associated with the deployment to manage, including for example to set up, the deployment. Deployment configuration does not define functionality of individual network elements 102, instead focusing on the deployment, for example the number of network elements in the deployment and how such elements are connected.

A translator node 126 is in various examples connected to the communications network 100. The translator node 126 is computer implemented functionality for generating desired configuration for injection into a network element 102 of a deployment, by aggregating received service and deployment configuration.

Configuration files specify desired configuration to be deployed in the communications network 100. A configuration file is written in a declarative form comprising a statement of a desired configuration (rather than a list of actions to take to reach the desired configuration), or in an imperative form. When a network element 102 which is designed to operate using imperative configurations receives a configuration file, the network element converts the declarative form of the configuration file into an imperative form in order to be able to attain the configuration specified in the configuration file.

In an approach, a configuration of the network element 102 is read each time a configuration file is received by the network element 102, in some cases from the virtualization layer 104. A difference between the received configuration file and the read configuration may then be computed, and the difference remedied by adjusting the configuration of the network element 102.

In some examples, the network element 102 comprises a configuration injector configured to receive a desired configuration, and apply the desired configuration to the network element 102. In some cases, the configuration injector is arranged to store a record of a configuration of the network element 102, compute a difference between the configuration of the network element 102 and the desired configuration, in some cases map a declarative desired configuration to an imperative desired configuration, and subsequently to send an imperative configuration to the network element for application. In some cases, the configuration injector applies the desired configuration to the network element.

In other cases, where the network element comprises a container, the container comprises a configuration injector with the same nature as outlined with respect to the network element 102 but that is configured to apply a received desired configuration to the container of the network element 102.

By enabling the configuration injector to store configuration it is possible for the configuration injector to compute the difference without having to read the configuration from the network element or container, which provides efficiency gains and reduces latency. In examples, each of the configuration injectors is arranged to update its record of the network element or container configuration in response to sending configuration in imperative form to the network element or container. This improves accuracy of the record of the configuration and reduces the need to read the configuration for every injection.

To facilitate scalable injection of desired configuration into a network element 102 and/or a plurality of network elements 102, in a way that is less time consuming and reduces a chance of introducing errors, a translator node 126 is provided that receives a service configuration and a deployment configuration, and aggregates the service and the deployment configuration to generate a desired configuration for injection into a network element 102 of a deployment.

A service configuration is a deployment-agnostic configuration i.e. configuration independent of deployment-specific information, and defines functionality to be applied to a deployment i.e. functionality to be applied to the plurality of network elements 102 comprised in the deployment. The service configuration treats the plurality of network elements 102 or the single network element 102 as a black box, in the sense that it does not define element-specific configuration, instead defining more generally a function or functions to be applied to the general plurality of network elements 102.

Examples of service configuration include routing rules, transcoding rules, firewall rules, network adjacencies, call services to apply, and/or billing configuration.

A deployment configuration is a deployment-specific configuration defining deployment-specific information associated with a network element of a deployment. In some cases a deployment configuration comprises deployment configuration associated with each network element 102 of a plurality of network elements 102 of the deployment. A deployment of a network element 102 or a plurality of network elements 102 refers to an instantiation of the network element(s) according to a particular deployment configuration. A non-exhaustive list of examples of deployment configuration is: number of network elements in a deployment, an address such as an Internet Protocol address of a network element 102, a topology of a plurality of network elements, a volume of traffic handleable by a network element 102, hardware associated with a network element 102, how a network element 102 is to be connected to a network, whether a network element 102 is to be connected to a sub-network, how a network element 102 is to be connected to a sub-network, a software version or image for a network element 102, operating system level configuration such as a host name associated with a network element 102, or any other deployment-specific information. A sub-network comprises some but not all nodes and edges of another network. A topology of a plurality of network elements refers to an arrangement of network elements and/or connections between them. In some cases, the above list of examples relates to a network element or plurality of network elements to be injected with desired configuration, and in other cases relates to a plurality of network elements of a deployment including an element to be injected with desired configuration. In various examples, service and/or deployment configuration is human-friendly, in the sense that it is more easily understood and configured than machine-readable configuration such as a MIB of a network element. In some cases service and/or deployment configuration is written in natural language or using a higher-level language than machine-level or MIB.

Aggregation of configuration refers to combining configuration to generate a desired configuration. In various examples, aggregation is performed by mapping functionality indicated by a service configuration to deployment-specific functionality using deployment information specified in deployment configuration. Decisions are made using contents of received deployment and service configuration in order to generate appropriate desired configuration, for example in the format of an MIB or a plurality of MIBs, for a network element, in some cases each network element of a deployment associated with the apparatus performing any of the methods described in this document. In some cases, an apparatus performing the aggregation of configuration (and in some cases the herein described methods) is configured in a deployment-specific way, such that it is running code specific to a deployment type. In some cases, the aggregation of configuration is performed by a container running in a Kubernetes (trade mark) cluster, or in any other deployment associated with an orchestrator,

In this way, deployment configuration is adjustable independently of service configuration. Desired configuration is generated in a scalable way in the sense that a single service configuration for example can be adjusted and applied to a plurality of network elements. A plurality of network elements are enabled to be injected with configuration to enable functionality defined by the service configuration without manual, tailored adjustment of each network element 102. Using deployment configuration, a plurality of network elements is enabled to be changed independently of a service configuration; resulting configuration changes or injections in each network element of the plurality of network elements are generated and enabled to propagate automatically.

In some cases, generating a desired configuration, as part of aggregating service and deployment configuration to generate a desired configuration for injection into a network element 102, includes mapping aggregated service and deployment configuration into a format suitable for injection into the network element 102, such as in the form of MIB.

In various examples, the desired configuration for injection into a network element comprises only information related to the network element, i.e. it does not comprise other information related to other network elements of a deployment comprising the network element where this other information is not needed for configuring the network element.

Moreover, by aggregating service and deployment configuration to generate desired configuration it is enabled that each element or portion of configuration in the deployment configuration and the service configuration is present in only one of the deployment configuration or the desired configuration. In this way, duplication of an adjustment to configuration across both deployment and service configuration that would otherwise be necessary is no longer required, for configuring a network element. Where the network element is of a deployment comprising at least one network element, a single service configuration and/or a single deployment configuration in various examples is received, and in some cases, aggregating the service configuration and the deployment configuration is performed to generate a desired configuration for each of, or at least one of, the network elements of the deployment. In some cases, the desired configuration for each of, or at least one of, the network elements of the deployment comprises only information related to the network element(s) that the respective desired configuration is for injection into, i.e. only information required to configure the network elements(s) as indicated by the service configuration. A desired configuration for injection into a network element comprises configuration as ‘desired’ i.e. as indicated by the service and the deployment configuration and as required to function as indicated by the service configuration.

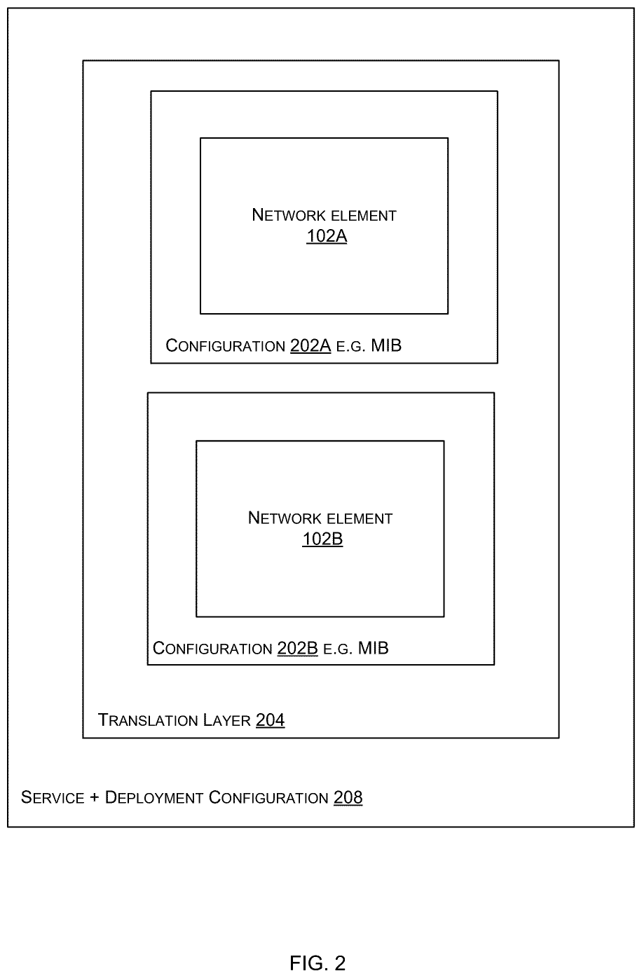

FIG. 2 is a schematic diagram of two network elements 102A, 102B of a deployment, with adjustable configuration 202A, 202B, in various examples each comprising an MIB. The MIB may be difficult for a human to understand.

Though two network elements 102A, 102B are illustrated, in various examples there is a plurality of network elements 102A, 102B each having a configuration 202A, 202B. In various examples, at least one network element 102A, 102B is a 5G communications network element, a Session Border Controller, and/or a container. In some examples, the plurality of network elements 102A, 102B is a pool or deployment of network elements, in some cases each being of a same type, such as each being Session Border Controllers, 5G network elements, routers, switches, or any other type of network element.

In various examples, a translation layer 204 is provided. The translation layer comprises software for translating configuration as explained below. In the example of FIG. 2 the translation layer 204 is shown as encompassing both network elements together. However, each network element may have its own translation layer in some cases. The translation layer generates desired configuration for injection into a network element 102A, 102B, in various examples each network element of the plurality of network elements 102A, 102B, in order to adjust a respective configuration 202A, 202B of the network element 102A, 102B into which the desired configuration is injected. In some cases, a desired configuration is tailored to each specific network element 102A, 102B, such that multiple network elements each are injected with a different desired configuration, and in other cases a same desired configuration is applied to multiple network elements 102A, 102B of the plurality of network elements.

The translation layer generates a desired configuration by aggregating a service configuration and a deployment configuration 208. In various examples, a single service configuration and/or a single deployment configuration relate to, i.e. are associated with, a plurality of network elements. In various examples, a single service configuration and/or a single deployment configuration are aggregated to generate a first desired configuration for injection into a first target network element 102A, 102B of a plurality of network elements, and to generate a second desired configuration for injection into a second target network element 102A, 102B of the plurality of network elements, where in various examples the first desired configuration and the second desired configuration are different. In some cases, a single service configuration and/or a single deployment configuration are aggregated to generate desired configuration, in some cases a same desired configuration or in other cases a plurality of desired configurations for respective network elements, for injection into a plurality of network elements.

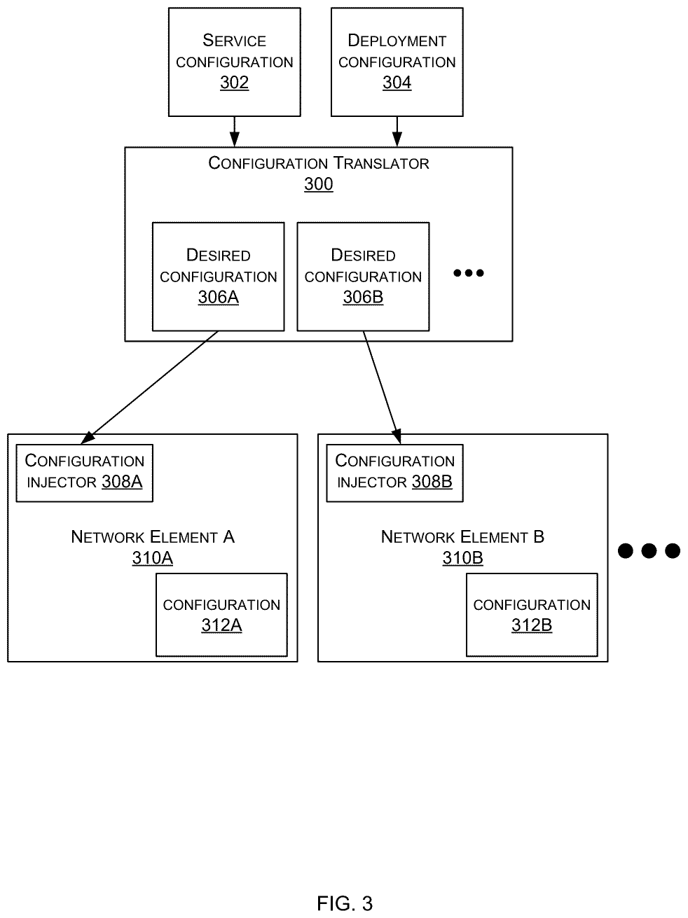

FIG. 3 shows a communications network comprising a configuration translator 300, a network element A 310A, and a network element B 310B. Other communications network nodes are present in the communications network but are not illustrated for clarity.

The configuration translator 300 receives a service configuration 302 and a deployment configuration 304. The service configuration may be received from an engineer or other entity (which may be automated) managing a service such as a voice over internet protocol service on the communications network. The deployment configuration may be queried from a virtualization layer. The configuration translator 300 then aggregates the service configuration 302 and the deployment configuration 304 to generate one or more desired configurations 306A, 306B. In various examples the desired configurations 306A, 306B, are for injection into the respective network elements 310A, 310B.

In some cases, the deployment configuration 304 is received by the configuration translator 300 from a virtualization layer (the configuration translator 300 may query the virtualization layer to obtain the deployment configuration), such as an virtualization layer associated with the plurality of network elements 310A, 310B, or another entity associated with a deployment comprising the network elements 310A, 310B. In some cases, the configuration translator 300 queries a virtualization layer or the other entity for the deployment configuration 304, such as in response to receiving a service configuration 302, every occurrence of a time period, and/or after a time has elapsed. In various examples, the virtualization layer is an orchestrator, non-exhaustively, Kubernetes (trade mark), Docker Swarm (trade mark), AWS CloudFormation (trade mark), Terraform (trade mark), Ansible (trade mark), Puppet (trade mark), Salt (trade mark). Other types of virtualization layer may be used where the network element is instantiated on a virtual machine without using a container. An virtualization layer being associated with a network element refers to the virtualization layer being configured to manage a deployment of the network element.

In various cases, the network elements 310A, 310B are containers, and in some cases the configuration translator 300 itself is a container. Containers in some cases are hosted by i.e. provided by a same hardware device, and in other cases are provided by independent hardware devices. In some cases the network elements are instantiated without containers and using virtual machines.

Configuration translator 300, in some cases initiates injection of a desired configuration 306A, 306B into a network element 310A, 310B, or a plurality of network elements. In some cases, configuration translator 300 injects a desired configuration 306A, 306B into a network element 310A, 310B. Injecting configuration into a network element, in various examples, comprises providing configuration to the network element, and applying the configuration. In some cases, as mentioned above, the network element 310A, 310B comprises a configuration injector 308A, 308B which is provided with a desired configuration 306A, 306B and which applies the desired configuration to the network element by, for example, changing a current configuration 312A, 312B of the network element.

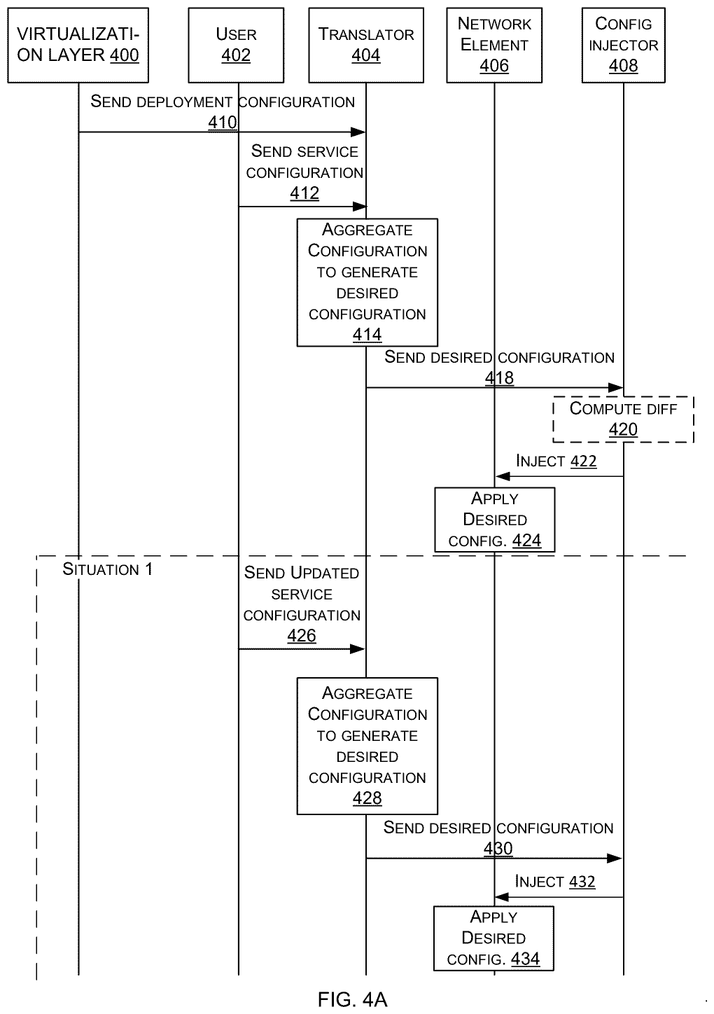

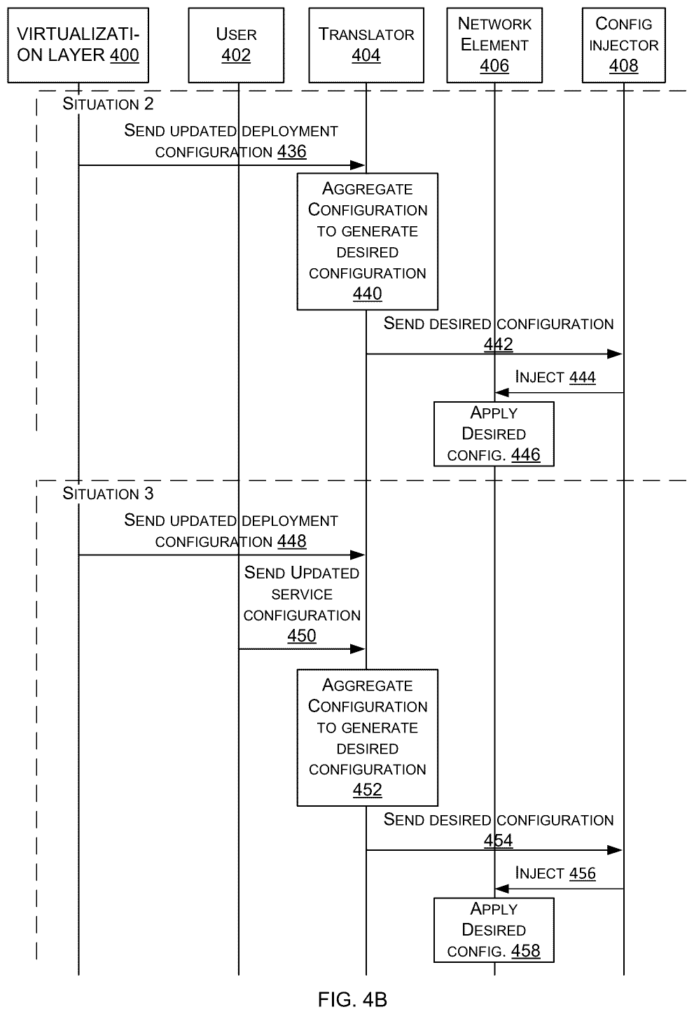

FIGS. 4A and 4B are flow diagrams of a method performed to generate a desired configuration using deployment and service configuration, for injection into a network element of a deployment. Such a method is in various examples performed by configuration translator 300 of FIG. 3, or a system comprising configuration translator 300.

In FIG. 4A, translator 404, corresponding to configuration translator 300 of FIG. 3 and in some cases being a container, receives a deployment configuration which in some cases is sent 410 by a virtualization layer 400 or retrieved from the virtualization layer by querying the virtualization layer. Though a single network element 406 is illustrated in FIG. 4A, it should be appreciated that a plurality of network elements 406 are in various examples provided and are comprised in a deployment, and in some cases a network element 406 is a container, and the virtualization layer 400 is associated with the network element 406. Deployment configuration defines deployment-specific information associated with the network element 406, in some cases each network element 406 of a plurality of network elements 406.

Translator 404 also receives a service configuration which in some cases is provided 412 by a user 402, or in other cases is provided by an entity such as the virtualization layer 400 or any other entity. Service configuration is deployment-agnostic configuration defining functionality to be applied to the deployment, i.e. functionality to be applied in some cases to a plurality of network elements 406 of the deployment.

Translator 404 aggregates the service configuration and the deployment configuration to generate a desired configuration 414 for injection into a target network element 406 of a deployment comprising a plurality of network elements 406 and in some cases for injection into each of or at least one of a plurality of target network elements 406 of a deployment.

In various examples, translator 404 initiates 418 injection 422 of the desired configuration into the target network element 406. This occurs, in some cases, by the translator 404 sending the desired configuration 418 to a configuration injector 408 of the network element 406, which then injects 422 the desired configuration which is applied 424 in the network element 406. As mentioned above, the configuration injector 408 in various examples computes a difference 420 between a received desired configuration and a current configuration of the associated network element 406, and then injects configuration to correct for the difference.

By enabling adjusting of configuration in a network element through a service configuration and a deployment configuration, a more scalable method of adjusting configuration of a network element is provided. The service configuration and the deployment configuration are enabled to be adjusted independently, as will now be illustrated.

In situation 1, translator 404 receives an updated service configuration, in various examples being provided 426 by a user 402, in some cases the same user as provided the initial service configuration 412 and in other cases a different user.

Translator 404 then aggregates the updated service configuration and the previously received deployment configuration, in various examples being a most recently received deployment configuration, to generate a desired configuration 428 for injection into the target network element 406.

In some cases, translator 404 initiates injection of the new desired configuration into the target network element 406, such as by sending the new desired configuration 430 to a configuration injector 408 associated with the target network element 306, which injects 432 the desired configuration and causes the target network element 306 to apply the desired configuration 434.

FIG. 4B illustrates two further situations, where like numerals indicate like elements with respect to FIG. 4A. In situation 2, translator 404 receives an updated deployment configuration, in various examples being provided 436 by a virtualization layer 400, in some cases the same virtualization layer as provided the initial deployment configuration 410 of FIG. 4A and in other cases a different virtualization layer.

Translator 404 then aggregates the updated deployment configuration and the previously received service configuration, in various examples being a most recently received service configuration, to generate a desired configuration 440 for injection into the target network element 406.

In some cases, translator 404 initiates injection of the new desired configuration into the target network element 406, such as by sending the new desired configuration 442 to a configuration injector 408 associated with the target network element 306, which injects 444 the desired configuration and causes the target network element 306 to apply the desired configuration 446.

In situation 3, translator 404 receives an updated service configuration, in various examples being provided 450 by a user 402, in some cases the same user as provided the initial service configuration 412 and in other cases a different user. Translator 404 further receives an updated deployment configuration, in various examples being provided 448 by a virtualization layer 400, in some cases the same virtualization layer as provided the initial deployment configuration 410 of FIG. 4A and in other cases a different virtualization layer.

Translator 404 then aggregates the updated service configuration and the updated deployment configuration to generate a desired configuration 452 for injection into the target network element 406.

In some cases, translator 404 initiates injection of the new desired configuration into the target network element 406, such as by sending the new desired configuration 454 to a configuration injector 408 associated with the target network element 306, which injects 456 the desired configuration and causes the target network element 306 to apply the desired configuration 458.

An updated configuration as mentioned above refers to a configuration that is adjusted in any way.

In some cases, aggregating service and deployment configuration to generate a desired configuration is performed in response to receiving an adjusted service configuration, in response to receiving an adjusted deployment configuration, after an elapsed time, with a delay after receiving an adjusted service configuration or an adjusted deployment configuration, at a certain time, and/or every repeat of a time period. Such a time or time period in various examples is 1 second, 1 day, 10 hours or any other time or time period, and such a certain time in some cases includes 10:00, 18:00, 20:00 or any other certain time.

Though situations 1 to 3 in FIG. 4A and FIG. 4B do not show the configuration injector 408 computing a difference 420, it should be appreciated that the configuration injector 408 does in some cases compute a difference upon receiving desired configuration for injection.

Additionally, though only a single network element 406 is illustrated, it should be appreciated that in various examples a plurality of network elements 406 are included, and that the translator 404 generates desired configuration for at least one network element of the plurality of network elements, where service configuration and deployment configuration, in some cases a single service and/or a single deployment configuration, are received for at least one network element of the plurality of network elements and where, in some cases, the translator 404 initiates injection of generated desired configuration into at least one element of the plurality of network elements.

The functionality of the translator 404 described herein is performed, additionally or alternatively, at least in part by one or more hardware logic components.

For example, and without limitation, illustrative types of hardware logic components that are optionally used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

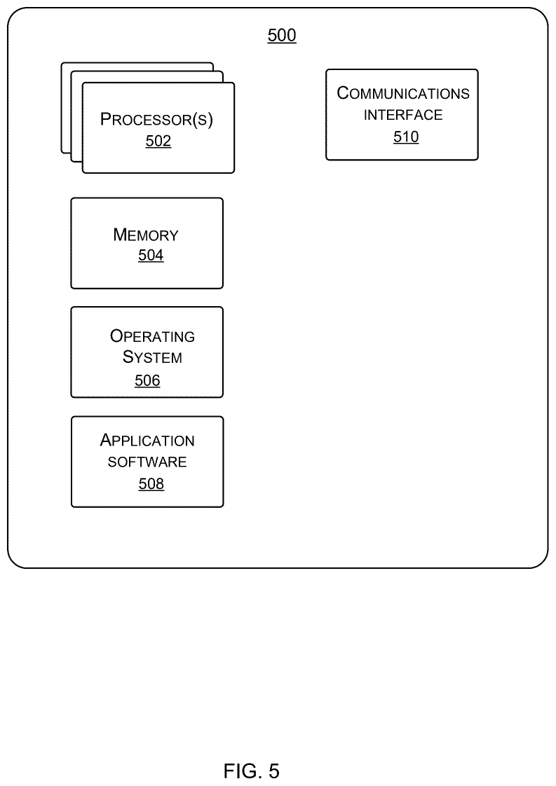

FIG. 5 illustrates various components of an exemplary computing-based device 500 which are implemented as any form of a computing and/or electronic device, and in which embodiments of the disclosed technology for generating desired configuration for injection into a network element are implemented in some examples.

Computing-based device 500 comprises one or more processors 502 which are microprocessors, controllers or any other suitable type of processors for processing computer executable instructions to control the operation of the device in order to generate desired configuration for injection into a network element. In some examples, for example where a system on a chip architecture is used, the processors 502 include one or more fixed function blocks (also referred to as accelerators) which implement a part of the method described with respect to FIGS. 3, 4A and 4B in hardware (rather than software or firmware). Platform software comprising an operating system 506 or any other suitable platform software is provided at the computing-based device to enable application software 508 to be executed on the device.

The computer executable instructions are provided using any computer-readable media that is accessible by computing based device 500. Computer-readable media includes, for example, computer storage media such as memory 504 and communications media. Computer storage media, such as memory 504, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 504) is shown within the computing-based device 500 it will be appreciated that the storage is, in some examples, distributed or located remotely and accessed via a network or other communication link (e.g. using communication interface 510).

Computing based device 500 in various examples is comprised in a communications network, such as a 5G communications network, that further comprises at least one network element. In some cases, computing based device 500 is a virtualization layer configured to communicate with a network element, is a virtualization layer configured to generate desired configuration for injection into a network element, is a network element, or is an entity that is independent of the network element for which desired configuration is generated and that is independent of a virtualization layer.

In various examples, communications interface 510 is used to receive service configuration, deployment configuration, and/or to initiate injection of configuration in a network element. Additionally, in various examples, computing based device 500 hosts, i.e. provides, a container which implements the technology disclosed herein. In some cases, computer-executable instructions stored by the memory 504, when executed by the processor 502, cause the container hosted by the computing-based device 500 to perform a method according to the herein disclosed technology.

Alternatively or in addition to the other examples described herein, examples include any combination of the following:

Clause A. A computer-implemented method for generating a desired configuration for injection into a first network element of a deployment comprising a plurality of network elements including the first network element, each network element comprised in a communications network, the method comprising:
receiving a service configuration, the service configuration being configuration independent of information about specific network elements, the service configuration defining functionality to be applied to the deployment;
receiving a deployment configuration defining information about deployment of the first network element; and
aggregating the service configuration and the deployment configuration to generate a desired configuration for injection into the first network element.

In this way, a method that improves an efficiency and scalability of configuration of a network element of a deployment is provided. A service and deployment configuration are enabled to be independently adjusted and network element configuration is generated, which is scalable in that a same service configuration is enabled to be applied to a deployment comprising more and a deployment comprising fewer network elements.

Clause B. The method of Clause A, wherein the service configuration defines at least one of: a routing rule, a transcoding rule, a firewall rule, a network adjacency, a call service to apply, and a billing configuration. In this way, specific elements of configuration related to functionality of a network element are provided in a scalable way, i.e. that are applicable to network elements of a deployment of at least one network element.

Clause C. The method of any preceding Clause, wherein the deployment configuration defines at least one of: a number of network elements in the deployment, a type of the first network element, an address of the network element, a topology of the plurality of network elements, a volume of traffic handleable by the first network element, hardware associated with the first network element, how the first network element is to be connected to a network, whether the first network element is to be connected to a sub-network, how the first network element is to be connected to a sub-network, a software version of the first network element, an image for the first network element, operating system level configuration of the first network element, and a host name associated with the first network element. In this way, specific elements of configuration related to deployment parameters of a deployment are provided in a scalable way.

Clause D. The method of any preceding Clause, further comprising initiating injection of the desired configuration into the first network element. In this way a network element is configured with configuration generated in a scalable and efficient manner.

Clause E. The method of any preceding Clause, wherein receiving the deployment configuration comprises querying a virtualization layer associated with the first network element. In this way, the provided method is implementable alongside a virtualization layer which may already exist in association with network elements to be configured.

Clause F. The method of any preceding Clause, the method performed by a container, and wherein the first network element is a container. In this way, an efficient, resource-manageable method is provided in a way that the method is enabled to be integrated into an existing deployment of containers.

Clause G. The method of any preceding Clause, further comprising receiving an adjusted service configuration and aggregating the adjusted service configuration and the deployment configuration to generate a second desired configuration for injection into the first network element. In this way, the service configuration is adjusted independently of the deployment configuration, without requiring duplication of configuration and therefore reducing a chance of errors that are difficult to debug.

Clause H. The method of any preceding Clause, further comprising receiving an adjusted deployment configuration and aggregating the adjusted deployment configuration and the service configuration to generate a third desired configuration for injection into the first network element. In this way, the deployment configuration is adjusted independently of the servicer configuration, without requiring duplication of configuration and therefore reducing a chance of errors that are difficult to debug.

Clause I. The method of any preceding Clause, wherein the first network element is a Session Border Controller, SBC. In this way, the method is applied to Session Border Controllers, enabling a scalable and efficient way of generating and adjusting configuration for a Session Border Controller in a deployment.

Clause J. The method of any preceding Clause, wherein the first network element is a 5G communications network element, and wherein the communications network is a 5G communications network. In this way, the method is applied to a 5G communications network and element, providing a scalable and efficient way of generating and adjusting configuration for elements in a 5G network.

Clause K. The method of any preceding Clause, wherein the deployment configuration defines deployment-specific information associated with each network element of the plurality of network elements, and wherein the method further comprises aggregating the service configuration and the deployment configuration to generate a second desired configuration for injection into a second network element of the plurality of network elements, wherein the second desired configuration is different to the desired configuration for injection into the first network element. In this way, a scalable and efficient method of configuring a plurality of different network elements of a deployment is provided, where the different network elements are injected with different configuration, which is more efficient and scalable than providing tailored configuration to each network element.

Clause L. The method of any preceding Clause, wherein the desired configuration comprises only information related to the first network element. In this way, the method is further made efficient, as the desired configuration comprises only relevant information for the network element.

Clause M. The method of any preceding Clause, wherein each portion of configuration in the deployment configuration and the service configuration is present in only one of: the deployment configuration, the desired configuration. In this way, there is no duplication of received configuration, reducing incidences of difficult to diagnose errors due to duplicated configuration elements having different values.

Clause N. An apparatus comprising:
a processor; and
a memory storing instructions that, when executed by the processor, perform a method for generating desired configuration for injection into a first network element of a deployment comprising a plurality of network elements including the first network element, each network element comprised in a communications network, the method comprising:
   receiving a service configuration, the service configuration being configuration independent of information about specific network elements, the service configuration defining functionality to be applied to the deployment;
   receiving a deployment configuration defining information about deployment of the first network element; and
   aggregating the service configuration and the deployment configuration to generate a desired configuration for injection into the first network element.

In this way, an apparatus is provided that improves an efficiency and scalability of configuration of a network element of a deployment. A service and deployment configuration are enabled to be independently adjusted and network element configuration is generated, which is scalable in that a same service configuration is enabled to be applied to a deployment comprising more and a deployment comprising fewer network elements.

Clause O. The apparatus of Clause N, the method further comprising initiating injection of the desired configuration into the first network element. In this way a network element is configured with configuration generated in a scalable and efficient manner.

Clause P. The apparatus of any of Clauses N and O, wherein receiving the deployment configuration is receiving the deployment configuration from a virtualization layer associated with the first network element. In this way, the provided apparatus has a method that is implementable alongside a virtualization layer which may already exist in association with network elements to be configured.

Clause Q. The apparatus of any of Clauses N to P, the memory storing instructions that, when executed by the processor, cause a container hosted by the apparatus to perform the method, and wherein the first network element is a container. In this way, an efficient, resource-manageable method performed by the apparatus is provided in a way that the method is enabled to be integrated into an existing deployment of containers.

Clause R. The apparatus of any of Clauses N to Q, the method further comprising receiving an adjusted service configuration and aggregating the adjusted service configuration and the deployment configuration to generate a second desired configuration for injection into the first network element. In this way, the service configuration is adjusted independently of the deployment configuration, without requiring duplication of configuration and therefore reducing a chance of errors that are difficult to debug.

Clause S. The apparatus of any of Clauses N to R, the method further comprising receiving an adjusted deployment configuration and aggregating the adjusted deployment configuration and the service configuration to generate a third desired configuration for injection into the first network element. In this way, the deployment configuration is adjusted independently of the servicer configuration, without requiring duplication of configuration and therefore reducing a chance of errors that are difficult to debug.

Clause T. A communications network comprising:
a plurality of network elements of a deployment, the plurality of network elements including a first network element;
an apparatus comprising:
   a processor; and
   a memory storing instructions that, when executed by the processor, perform a method for generating desired configuration for injection into the first network element, comprising:
      receiving a service configuration, the service configuration being configuration independent of information about specific network elements, the service configuration defining functionality to be applied to the deployment;
      receiving a deployment configuration defining information about deployment of the first network element; and
      aggregating the service configuration and the deployment configuration to generate a desired configuration for injection into the first network element.

In this way, a communications network with an improved efficiency and scalability of a process of configuring a network element of a deployment is provided. A service and deployment configuration are enabled to be independently adjusted and network element configuration is generated, which is scalable in that a same service configuration is enabled to be applied to a deployment comprising more and a deployment comprising fewer network elements.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

What is claimed is:

1. A computer-implemented method for generating a desired configuration for injection into a first network element of a deployment comprising a plurality of network elements including the first network element, each network element comprised in a communications network, the method comprising:
receiving a service configuration, the service configuration being configuration independent of information about specific network elements, the service configuration defining functionality to be applied to the deployment;
receiving a deployment configuration defining information about deployment of the first network element; and
aggregating the service configuration and the deployment configuration to generate a desired configuration for injection into the first network element.

2. The method of claim 1, wherein the service configuration defines at least one of: a routing rule, a transcoding rule, a firewall rule, a network adjacency, a call service to apply, or a billing configuration.

3. The method of claim 1, wherein the deployment configuration defines at least one of: a number of network elements in the deployment, a type of the first network element, an address of the first network element, a topology of the plurality of network elements, a volume of traffic handleable by the first network element, hardware associated with the first network element, how the first network element is to be connected to a network, whether the first network element is to be connected to a sub-network, how the first network element is to be connected to a sub-network, a software version of the first network element, an image for the first network element, operating system level configuration of the first network element, and a host name associated with the first network element.

4. The method of claim 1, further comprising initiating injection of the desired configuration into the first network element.

5. The method of claim 1, wherein receiving the deployment configuration comprises querying a virtualization layer associated with the first network element.

6. The method of claim 1, wherein the method is performed by a first container, and wherein the first network element is a second container.

7. The method of claim 1, further comprising receiving an adjusted service configuration and aggregating the adjusted service configuration and the deployment configuration to generate a second desired configuration for injection into the first network element.

8. The method of claim 1, further comprising receiving an adjusted deployment configuration and aggregating the adjusted deployment configuration and the service configuration to generate a third desired configuration for injection into the first network element.

9. The method of claim 1, wherein the first network element is a Session Border Controller (SBC).

10. The method of claim 1, wherein the first network element is a 5G communications network element, and wherein the communications network is a 5G communications network.

11. The method of claim 1, wherein the deployment configuration defines information associated with each network element of the plurality of network elements, and wherein the method further comprises aggregating the service configuration and the deployment configuration to generate a second desired configuration for injection into a second network element of the plurality of network elements, wherein the second desired configuration is different to the desired configuration for injection into the first network element.

12. The method of claim 1, wherein the desired configuration comprises only information related to the first network element.

13. The method of claim 1, wherein each portion of configuration in the deployment configuration and the service configuration is present in only one of: the deployment configuration or the desired configuration.

14. An apparatus comprising:
a processor; and
a memory storing instructions that, when executed by the processor, perform operations for generating a desired configuration for injection into a first network element of a deployment comprising a plurality of network elements including the first network element, each network element comprised in a communications network, the operations comprising:
receiving a service configuration, the service configuration being configuration independent of information about specific network elements, the service configuration defining functionality to be applied to the deployment;
receiving a deployment configuration defining information about deployment of the first network element; and
aggregating the service configuration and the deployment configuration to generate a desired configuration for injection into the first network element.

15. The apparatus of claim 14, the operations further comprising initiating injection of the desired configuration into the first network element.

16. The apparatus of claim 14, wherein receiving the deployment configuration is receiving the deployment configuration from a virtualization layer associated with the first network element.

17. The apparatus of claim 14, the memory storing instructions that, when executed by the processor, cause a first container hosted by the apparatus to perform the operations, and wherein the first network element is a second container.

18. The apparatus of claim 14, the operations further comprising receiving an adjusted service configuration and aggregating the adjusted service configuration and the deployment configuration to generate a second desired configuration for injection into the first network element.

19. The apparatus of claim 14, the operations further comprising receiving an adjusted deployment configuration and aggregating the adjusted deployment configuration and the service configuration to generate a third desired configuration for injection into the first network element.

20. A communications network comprising:
a plurality of network elements of a deployment, the plurality of network elements including a first network element; and
an apparatus comprising:
a processor; and
a memory storing instructions that, when executed by the processor, perform operations for generating desired configuration for injection into the first network element, comprising:
receiving a service configuration, the service configuration being configuration independent of information about specific network elements, the service configuration defining functionality to be applied to the deployment;
receiving a deployment configuration defining information about deployment of the first network element; and
aggregating the service configuration and the deployment configuration to generate a desired configuration for injection into the first network element.
